(19) United States
(12) Patent Application Publication
(10) Pub. No.: US 2025/0239870 A1
(43) Pub. Date: Jul. 24, 2025

(54) Vehicle Charging Circuit With A Two-Stage Discharge Process Via A DC-DC Converter And A Passive Discharge Circuit

(71) Applicant: Schaeffler Technologies AG & Co. KG, Herzogenaurach (DE)

(72) Inventors: Waldemar Heimann, Regensburg (DE); Michael Kausche, Hannover (DE); Juan Alberto Romero Baena, Regensburg (DE)

(73) Assignee: Schaeffler Technologies AG & Co. KG, Herzogenaurach (DE)

(21) Appl. No.: 19/176,633

(22) Filed: Apr. 11, 2025

Related U.S. Application Data
(63) Continuation of application No. PCT/EP2023/078034, filed on Oct. 10, 2023.

(30) Foreign Application Priority Data
Oct. 13, 2022 (DE) 10 2022 210 814.0

(51) Int. Cl. H02J 7/00; B60L 58/14

(52) U.S. Cl. CPC H02J 7/0029; B60L 58/14; H02J 2207/20; H02J 2207/50

(57) ABSTRACT

A discharge process of an intermediate circuit capacitor in two stages using two different circuits is proposed. A discharge circuit is used (which is also used for pre-charging), includes a first changeover switch used to choose between directly linking the intermediate circuit capacitor to a first DC voltage terminal and linking further pre-charge/discharge components used to discharge the intermediate circuit capacitor. These components include a second changeover switch used to select between pre-charging and discharging, allowing a selection to pre-charge the intermediate circuit capacitor with a limited current or to discharge it. A DC voltage converter is also attached to the intermediate circuit capacitor. In a first discharge phase, the DC voltage converter is operated for discharging purposes to only produce a power loss in the form of heat but does not produce a power transfer. The subsequent second discharge phase provides a discharge by way of the discharge circuit.

### CROSS-REFERENCE TO RELATED APPLICATIONS

This application claims the benefit of PCT Application PCT/EP2023/078034, filed Oct. 10, 2023, which claims priority to German Application 10 2022 210 814.0, filed Oct. 13, 2022. The disclosures of the above applications are incorporated herein by reference.

### TECHNICAL FIELD

The disclosure relates to a vehicle charging circuit with a two-stage discharge process via a DC-DC converter and a passive discharge circuit.

### BACKGROUND

Vehicles with an electric drive have a traction battery which is operated with high voltages, for example with voltages of more than 200, 400 or 600 volts. In addition to this energy store, there are intermediate circuit capacitors, that is to say back-up capacitors, which are found on the input side of voltage converters or current converters. Such intermediate circuit capacitors are provided particularly in on-board charging power supply lines, for example on a DC voltage side of a rectifier, can be fed into the alternating current for charging, or else in DC voltage converters within a charging path.

In order to avoid hazards, in particular when charging, not only should the traction battery be disconnected and provided with safety measures such as insulation, but safety measures are also required in order to prevent a discharge, which originates from an intermediate circuit capacitor, leading to a dangerously high touch current for the user.

### SUMMARY

The disclosure therefore provides intermediate circuit capacitors to be discharged safely and cost-effectively such as in a charging circuit of a vehicle. This object is achieved by the vehicle charging circuit as claimed in claim 1. Further

The discharge process is carried out in two stages, that is to say by way of two different circuits. On one hand, a discharge circuit is used (which is also used for pre-charging), in which a first changeover switch is used to choose between directly linking the intermediate circuit capacitor to a first DC voltage terminal and linking further pre-charge/discharge components which are used to discharge the intermediate circuit capacitor. These components include a second changeover switch which is used to select between pre-charging and discharging, that is to say with which a selection can be made to pre-charge the intermediate circuit capacitor with a limited current (by way of at least one resistor) or to discharge it. A further way for discharging is a DC voltage converter which is also attached to the intermediate circuit capacitor. The DC voltage converter is operated for discharging purposes in such a way that it only produces a power loss in the form of heat but does not produce a (substantial) power transfer.

It is proposed to use the DC voltage converter initially for discharging, because it (due to its further function as a DC voltage converter in a charging path) has components which are configured for high currents. In a second phase of the discharging, the described (passive) discharge circuit is used, which enables more precise and rapid discharging even when the residual voltage of the intermediate circuit capacitor is low. As a result, in a first discharge phase in which the discharging is carried out via the DC voltage converter, the high current-carrying capacity according to which the DC voltage converter is configured can be used for discharging, such as to allow high discharge currents and also so as to be able to process (still) high operating voltages of the intermediate circuit capacitor.

With the second phase, which is carried out by way of the discharge circuit and a resistor, the further discharging can be carried out in a simple and targeted manner, where the discharge circuit and the resistor do not have to be configured for high outputs (or not high operating voltages), for example not for discharge output, such as may arise in the first phase when the capacitor is in a high charging state. Cost savings are achieved, because resistors and switches which are configured in accordance with lower outputs are less expensive in comparison with components which are configured for higher output. In some examples, this means that complex cooling of the discharge resistor can be dispensed with, because the resistor is heated only in the second discharge phase, not in the first. In the first discharge phase, the discharge circuit is designed to provide the discharge current fully by way of the DC voltage converter, where no discharge current (i.e. no discharge current that is essential for the discharge resistor heating) flows through the discharge resistor. The discharge circuit is designed to disconnect the (one or more) discharge resistor from the intermediate circuit capacitor in the first discharge phase, such as by way of the switching position of at least one changeover switch. The total quantity of heat to be drawn is therefore lower for the discharge resistor than in circuits which provide only a resistor for discharging. This is relevant in discharge circuits in which one and the same resistor is used for pre-charging and for discharging, since the resistor may already be heated by the pre-charging, and discharging would further increase the temperature.

A vehicle charging circuit implements this procedure as follows. The vehicle charging circuit has a first DC voltage terminal and a second DC voltage terminal. The first DC voltage terminal is not necessarily the charging terminal, but a rectifier can be arranged upstream of the first DC voltage terminal, and therefore the vehicle charging circuit can be a charging circuit for alternating current. The charging circuit has a DC voltage converter, upstream of which there is an intermediate circuit capacitor. The charging circuit furthermore has a pre-charge/discharge circuit. This is attached to the intermediate circuit capacitor. In some examples, the first DC voltage terminal is connected to the intermediate circuit capacitor via the pre-charge/discharge circuit. The pre-charge/discharge circuit may be designed to isolate this connection in a controllable manner or to provide it with an interconnected (pre-charge) resistor. The second DC voltage terminal is connected to the intermediate circuit capacitor via the DC voltage converter. In other words, the charging circuit has two ends which are provided by the first and the second DC voltage converter, where the two DC voltage terminals are connected to one another via the pre-charge/discharge circuit and the DC voltage converter. If the vehicle charging circuit includes a rectifier upstream of the first DC voltage terminal, then the alternating-current side of the rectifier forms a first end and the second DC voltage terminal forms a second, opposite end of the charging circuit.

In some implementations, the first DC voltage terminal, the pre-charge/discharge circuit, the intermediate circuit capacitor and the DC voltage converter, followed by the second DC voltage terminal, are provided one after another in this order.

The pre-charge/discharge circuit has at least one first changeover switch. The changeover switch is designed to connect the first pole of the intermediate circuit capacitor either to a first potential of the first DC voltage terminal (so as to produce a direct connection) or to the second pole of the intermediate circuit capacitor via a discharge resistor and a second changeover switch. The first option corresponds to the first position and the second option corresponds to the second position. The possible connection of the first pole of the intermediate circuit capacitor to a second pole via a discharge resistor and a second changeover switch can initially go via the discharge resistor and then via the second changeover switch, or initially via the second changeover switch and then via the discharge resistor, before the second pole of the intermediate circuit capacitor is reached. The first changeover switch is used either to enable a flow of power from the first DC voltage terminal to the intermediate circuit capacitor or to the DC voltage converter by way of the direct connection or, in the other switching position, to realize a pre-charge or discharge function (via the second changeover switch).

The second changeover switch connects the discharge resistor optionally to the first potential of the first DC voltage terminal or to the second pole of the intermediate circuit capacitor. These two connection options can be chosen individually in each case, but not at the same time. The state in which the second changeover switch connects the discharge resistor to the first potential of the first DC voltage terminal corresponds to a first switch position (which can also be referred to as a pre-charging position). In this switch position, pre-charging is performed via the discharge resistor, and therefore the term pre-charge resistor would also be applicable to this function. The designation as a discharge resistor does not limit the function thereof merely to discharging, rather it only means that the resistor can be used for discharging. As mentioned, this resistor can also be used for pre-charging, where the term discharge resistor is not intended to exclude this. Instead of “discharge resistor”, this can also be referred to as a current-limiting resistor. In the second switch position of the second changeover switch, the latter connects the discharge resistor to the second pole of the intermediate circuit capacitor. The second switch position can be referred to as a discharging position. The second pole of the intermediate circuit capacitor has a potential which corresponds to the second potential of the DC voltage terminal. In some examples, the first changeover switch connects only in a first busbar, which the first potential of the first DC voltage terminal to the first pole of the intermediate circuit capacitor in a switchable manner. A second busbar of the opposite polarity connects the second potential of the first DC voltage terminal to the second pole of the intermediate circuit capacitor, but without intermediate connection of the first and/or of the second changeover switch.

In the above-mentioned interconnection of the second changeover switch, the discharge resistor is arranged downstream of the first changeover switch, where the second changeover switch in turn is arranged downstream of the discharge resistor. This enables the use of one and the same resistor for discharging and for pre-charging, that is to say generally for voltage limiting (for which reason the relevant resistor can also be referred to as a current-limiting resistor).

A further option entails reversing the order of the second changeover switch and the discharge resistor in relation to the first changeover switch. In this variant, the second changeover switch is arranged directly downstream of the first changeover switch, where the discharge resistor is arranged downstream of the second changeover switch. It can therefore be envisioned that the second changeover switch connects the first changeover switch to the first potential of the first DC voltage terminal optionally in a first switch position via a pre-charge resistor and to the discharge resistor in a second switch position. In this case, there are two different resistors, specifically a pre-charge resistor and a discharge resistor, which are connected from the second changeover switch to the first changeover switch depending on the switch position of the second changeover switch. The use of two different resistor elements for the two functions of discharging and pre-charging makes it possible to have a matching configuration and also has advantages in terms of thermal management, since a pre-charging process does not heat the discharge resistor and vice versa.

In some implementations, the vehicle charging circuit furthermore includes an activation unit (such as an activation circuit), which, in a first discharge phase, is designed to activate the DC voltage converter to convert the voltage or charge of the intermediate circuit capacitor (partially) into heat. The first discharge phase does not end with the complete discharging of the intermediate circuit capacitor, but ends with the beginning of a second charging phase. In this second charging phase, the activation unit reverses the first and the second changeover switch, in each case to adopt the second position. In other words, in the second discharge phase, the activation unit activates the first changeover switch to connect the first pole of the intermediate circuit capacitor to the second changeover switch or to the discharge resistor, and activates the second changeover switch to produce a connection from the second pole of the intermediate circuit capacitor to the first changeover switch via the discharge resistor. In this case, it can be envisioned that, in the second discharge phase, the second changeover switch connects the first changeover switch to the discharge resistor, which in turn is connected to the second pole of the intermediate circuit capacitor, or it can be envisioned that the discharge resistor is connected to the second pole of the intermediate circuit capacitor via the second changeover switch. Instead of the term “second pole of the intermediate circuit capacitor”, the term “second potential of the first DC voltage terminal” can also be used, since these are directly connected to one another and have the same potential.

As a result of the division into a first discharge phase, in which the rectifier discharges the intermediate circuit capacitor, and a second discharge phase, in which the discharge circuit presented here discharges the intermediate circuit capacitor passively, no particularly high output values are required for the discharge resistor, even when the intermediate circuit capacitor has high energy contents, because some of the energy of the intermediate circuit capacitor, such as the majority, is converted into heat by the DC voltage converter. If, for example, the control unit of the DC voltage converter is fed by the input voltage thereof, a controlled active discharge can furthermore be carried out by way of the DC voltage converter, without the latter entering into unsafe operation, since the passive discharge circuit takes over after a certain charging voltage of the intermediate circuit capacitor during discharge.

The first changeover switch, the second changeover switch or both changeover switches may be designed to adopt the second position in an activation-free state. Therefore, if the activation signal for the first changeover switch is missing, the latter is designed to isolate the first pole of the intermediate circuit capacitor from the first potential of the DC voltage terminal (and, instead, to connect this first potential to the second changeover switch or to the discharge resistor). In the activation-free state, the second changeover switch provides that the first changeover switch is connected (directly or via the discharge resistor) to the second pole of the intermediate circuit, and is isolated from the first potential of the DC voltage terminal.

In some implementations, the vehicle charging circuit is formed as a direct-current charging circuit. In this case, the first DC voltage terminal is connected to a charging plug socket in a rectifier-free manner (such as a plug-in charging socket), or forms such a charging socket itself. Further examples provide that the vehicle charging circuit is an alternating-current charging circuit, such as a single-phase or three-phase charging circuit. In this case, the vehicle charging circuit has a controlled rectifier or a power factor correction filter (PFC, Power Factor Correction). In some examples, the vehicle charging circuit has a controlled rectifier. The rectifier or the power factor correction filter has a direct-current side which is connected to the first DC voltage terminal (such as in a converter-free manner). The rectifier or the power factor correction filter has an alternating-current side. This is connected to a single-phase or three-phase alternating-current terminal.

The rectifier can be formed in one part or formed in two parts. The rectifier can have two (or more) rectifier circuits serially connected on the direct-current side. The rectifier circuits may be constructed identically. Each rectifier circuit has a positive and a negative terminal on the direct-current side. The positive terminal of a first rectifier circuit is connected to the negative terminal of the second rectifier circuit, giving rise to a series circuit. The two outer terminals, that is to say the positive terminal of the second circuit and the negative terminal of the first rectifier circuit, are connected to the first DC voltage terminal or to the potentials thereof. In other words, the rectifier circuits are connected in series on the direct-current side thereof, wherein the resulting series circuit is attached to the first DC voltage terminal.

In some implementations, the intermediate circuit capacitor is formed in two parts, and therefore includes two capacitor elements serially connected to one another, where the resulting series circuit is attached to two different potentials of the intermediate circuit. This corresponds to a two-part construction of the intermediate circuit capacitor, the first and second pole of which is formed by the outer terminals of the two serially connected capacitor elements. The intermediate circuit capacitor, which has two serial capacitor elements, is connected to the second DC voltage terminal via the DC voltage converter. In some examples, the pre-charge or discharge circuits described here are provided for each of the capacitor elements of the intermediate circuit capacitor (two or more). In this case, each pre-charge or discharge circuit includes the first and the second changeover switch, a discharge resistor and optionally also a pre-charge resistor. In this case, the two pre-charge/discharge circuits are constructed as a mirror-image in relation to the connecting point of the series circuits. The series circuits in this case relate to the series circuits of the rectifier circuits or the capacitor elements of the multi-part intermediate circuit capacitor. When using a plurality of connected rectifier circuits as a rectifier, that is to say in the case of multi-part rectifiers, a capacitor element can be provided for each rectifier circuit. This then only has to be configured for a fraction of the total voltage of the entire intermediate circuit capacitor. The fraction arises from the reciprocal of the number of rectifier circuits which are serially connected.

In some implementations, the DC voltage converter is a resonant DC voltage converter. In some examples, the DC voltage converter is a galvanically non-isolating DC voltage converter. Examples provide that the DC voltage converter has a resonant circuit and switches connected thereto. The switches are connected to one another in the form of two half-bridges, for example, where the half-bridges each have two transistors. Each half-bridge is connected by the outer ends to the poles of the intermediate circuit capacitor. Each half-bridge has a connecting point, where the connecting points of two half-bridges are connected via a resonant circuit. Resonant circuit has a capacitor and an inductance, for example. This gives a serial resonant circuit. The activation unit is designed to operate the DC voltage converter outside the resonant frequency of the resonant circuit in the first discharge phase. For example, this operating frequency lies above the resonant frequency in the first discharge phase. The resonant frequency is derived from the inductances of the resonant circuit. The activation unit is furthermore designed to provide the DC voltage converter in an inactive state in the second discharge phase, that is to say in a state in which the switches are open. The switches of the DC voltage converter which are described here can also be referred to as working switches.

The activation unit can additionally be designed to open and to close the switches in a timed manner with a timed signal in a converter operation state, where the frequency of this signal substantially corresponds to the resonant frequency of the resonant circuit. This gives a voltage conversion, where the resonant circuit is energized at the resonant frequency. The vehicle charging circuit can have a converter terminal which is connected to the connecting points of the half-bridges or to the ends of the resonant circuit. There, the converter produces a voltage in the converter state, which voltage is fed by the voltage via the intermediate circuit capacitor.

The switches or working switches of the DC voltage converter form two half-bridges, each with a connecting point. The half-bridges are attached (parallel) to the intermediate circuit capacitor. The connecting points, which form two poles of the second DC voltage terminal, are connected to one another via the resonant circuit. The connecting points are alternating-current potentials within the converter and may be connected to the second DC voltage terminal via a converter-rectifier circuit (controlled or uncontrolled). The second DC voltage terminal is connected to the intermediate circuit capacitor via the DC voltage converter. This in turn is connected to the rectifier or to the first DC voltage terminal via the at least one pre-charge/discharge circuit.

The DC voltage converter has a converter-rectifier circuit, the direct-current side of which is connected to the second DC voltage terminal, and the alternating-current side of which is connected to the resonant circuit or the connecting points of the DC voltage converter.

In some implementations, the activation unit is designed to activate an isolation device and/or a controllable rectifier circuit arranged upstream of the first DC voltage terminal into an open switching position before the first discharge phase. In some examples, the first and the second discharge phase are performed while the activation unit activates this open switching position. In the open switching position, the first DC voltage terminal is isolated from a current source, such as a charging current source, from which the first DC voltage terminal is fed during charging. In an active converter state, the isolating device is closed and the rectifier circuit is activated in a timed manner. In the first and in the second charging phase, the activation unit activates the rectifier circuit with a continuous open switching position, while a timed operation in a converter phase or charging phase is provided.

The activation unit is designed to transition from the first discharge phase into the second discharge phase if the voltage applied to the intermediate circuit capacitor falls below a predetermined limit value. Alternatively or in combination therewith, the activation unit is designed to transition from the first discharge phase into the second discharge phase if only a predetermined fraction of the maximum possible, nominal or originally existing charge is still provided in the intermediate circuit capacitor. The activation unit can be designed to perform the first discharge phase for a predetermined duration (and then to transition into the second discharge phase). As a result of this duration, taking into account the capacitance of the intermediate circuit capacitor and, where appropriate, the operating voltage (i.e. the original operating voltage) of the intermediate circuit capacitor, there is a reduced voltage at the intermediate circuit capacitor after the predefined discharge duration in the first discharge phase.

The activation unit can have a measurement device or be connected to such a measurement device which detects the voltage via the intermediate circuit capacitor, and which determines if a predetermined limit value has been undershot. Alternatively, the activation unit can have the function of comparing the measured voltage at the intermediate circuit capacitor with the predetermined limit value. In both cases, the activation unit transitions from the first into the second charging phase if the limit value is undershot. The limit value can correspond, for example, to 50 percent, 15 percent or five percent of a nominal voltage at the intermediate circuit capacitor, for example a nominal voltage of 800, 400 or 600 volts. The limit value can be, for example, greater than 60 volts, such as greater than 100 or 200 volts, and/or for example less than 200 volts, 100 volts, 80 volts or 60 volts.

In some implementations, the activation unit is designed, in a first discharge phase, to activate the first changeover switch in the second position, and to activate the second changeover switch in the first position. The activation unit is designed, in the first discharge phase, to activate the first changeover switch to connect the first pole of the intermediate circuit capacitor to the second changeover switch (via a resistor or the discharge resistor between the changeover switches or directly). The activation unit is designed, in the first discharge phase, to activate the second changeover switch to connect the first changeover switch to the first potential of the first DC voltage terminal (via the mentioned resistor or via a direct connection between the changeover switches). In some examples, a diode is arranged upstream of the first DC voltage terminal or an isolating switch, where the control unit is designed to provide the isolating switch in the open state in the first (and for example, also in the second) discharge phase. A first diode can be arranged upstream of the first potential of the first DC voltage terminal and a second diode can be arranged upstream of the second potential of the first DC voltage terminal. The forward direction thereof is provided in such a way that a flow of current from the first DC voltage terminal to the second DC voltage terminal is made possible and the flow of current is blocked in the opposite direction. An all-pole isolating switch can also be arranged upstream of the first DC voltage terminal, which all-pole isolating switch is opened at all poles by the control unit in the discharge phases. A DC voltage supply terminal can be provided, which is connected to the first DC voltage terminal via the at least one diode or via the (single-pole or all-pole) isolating switch. During the discharge phases, the at least one diode or the at least one isolating switch are used to suppress a flow of current from an external voltage source (charging current source) into the discharge circuit or are used to suppress a flow of current from the intermediate circuit capacitor or a flow of current via the discharge circuit to an external charging terminal, in order thus to suppress hazardous touch voltages there. If a rectifier is arranged upstream of the first DC voltage terminal, the at least one diode or the at least one isolating switch can be obsolete, because the rectifier can realize the disconnection of the discharge circuit or of the intermediate circuit capacitor with respect to an external terminal.

The details of one or more implementations of the disclosure are set forth in the accompanying drawings and the description below. Other aspects, features, and advantages will be apparent from the description and drawings, and from the claims.

### DESCRIPTION OF DRAWINGS

FIGS. 1 to 3 show exemplary vehicle charging circuits described here and are used to explain different examples or functions of the circuit.

Like reference symbols in the various drawings indicate like elements.

### DETAILED DESCRIPTION

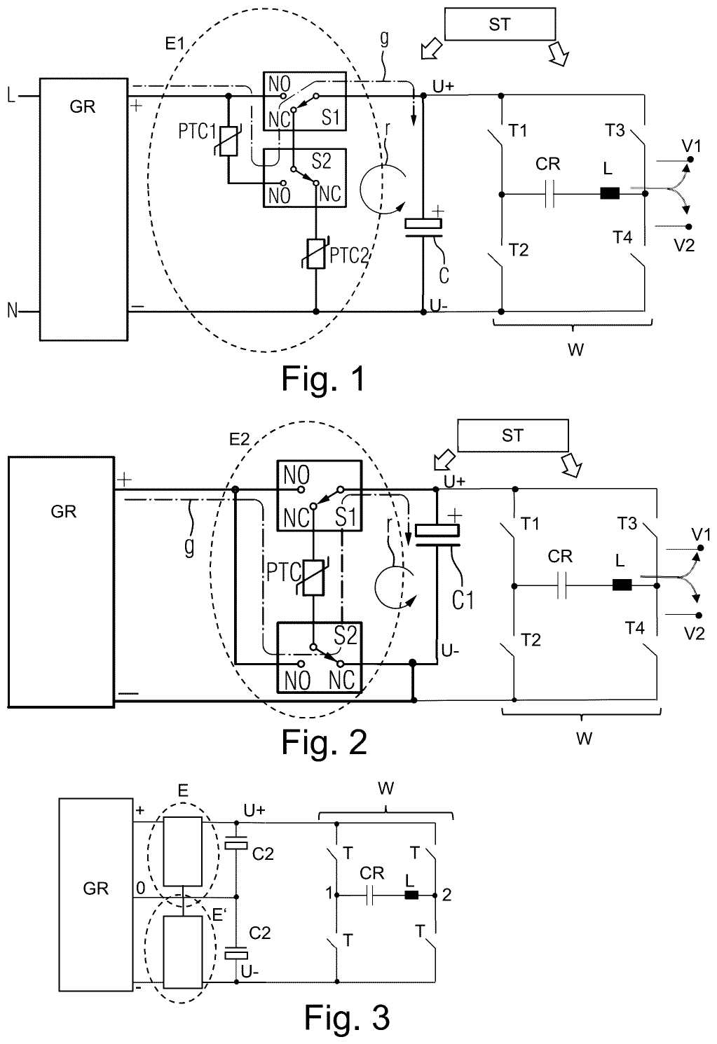

FIG. 1 shows a vehicle charging circuit with a rectifier GR, the alternating-current side of which is connected to the alternating-current terminals L and N. N can be the neutral conductor terminal and L the phase terminal. In some examples, the rectifier is a controlled rectifier. All circuits which are able to rectify an alternating voltage are referred to herein as rectifiers. The rectifier may be a power factor correction filter (that is to say, a circuit with a rectifying and DC-voltage-converting function). The DC voltage side of the rectifier forms the first DC voltage terminal +, −. An intermediate capacitor C (component C1 in FIG. 2) is connected to the first DC voltage terminal via a first changeover switch S1. In some examples, the first rectifier connects the positive pole U+ of the intermediate circuit capacitor C, C1 to the positive potential + of the first DC voltage terminal. The negative potential of the first DC voltage terminal − is connected directly, that is to say not via a changeover switch, to the negative pole U− of the intermediate circuit capacitor C, C1.

A DC voltage converter W, which has four transistors T1 to T4, attaches to the intermediate circuit capacitor. These are connected to one another in two half-bridges, such that the transistors T1, T2 form a first half-bridge and the capacitors T3 and T4 a second half-bridge of the DC voltage converter W. A resonant circuit with the inductance L and the capacitor C form a serial resonant circuit. It is shown symbolically that a second DC voltage terminal V1, V2 is connected to the resonant circuit. In this case, the resonant circuit CR, L is connected to the second DC voltage terminal V1, V2 via a converter-rectifier circuit (this is shown only symbolically). The converter-rectifier circuit can be a controlled or uncontrolled rectifier circuit, such as a full-wave rectifier circuit.

Finally, an activation unit ST is provided, which activates the changeover switches of the pre-charge/discharge circuit E1, E2 and also, directly or indirectly, the transistors T1 to T4 of the DC voltage converter W. The above remarks regarding FIG. 1 also apply to FIG. 2. The different forms of the pre-charge/discharge circuit E1, E2 of FIGS. 1 and 2 are presented in the following text.

In FIG. 2, a second changeover switch S2 is provided, which is arranged downstream of the changeover switch S1. The changeover switch S1 optionally connects either the positive pole U+ of the intermediate circuit capacitor C to the positive pole of the first DC voltage terminal +, see switch position NO or directly to the second changeover switch S2, see switch position NC. In contrast to this, the changeover switch S1 of FIG. 2 connects the positive pole U+ of the intermediate circuit capacitor C1 not directly to a changeover switch, but to a discharge resistor PTC (in general: current-limiting resistor PTC), which leads to the second changeover switch S2 of FIG. 2. In FIG. 2, the second changeover switch S2 then connects the resistor PTC either to the positive potential + of the first DC voltage terminal, see switch position NO, or to the negative pole U− of the intermediate circuit capacitor C1, see switch position NC. In the last-mentioned switch position, the second changeover switch S2 connects the resistor PTC to the negative potential − of the first DC voltage terminal.

In FIG. 2, a pre-charge can therefore be provided in the switch position NO of the changeover switch S2 via the resistor PTC, corresponding to the flow of current g which passes via the first changeover switch S1 which is in the circuit NC. If the changeover switch S1 is in the switch position NC and the changeover switch S2 is in the switch position NC, then this gives a parallel connection of the resistor PTC to the intermediate circuit capacitor C1, in order thus to perform a discharge in accordance with the current path r.

In FIG. 1, the changeover switch S2 is arranged directly downstream of the changeover switch S1. If the changeover switch S1 is in the switch position NC and the changeover switch S2 is in the switch position NO, this gives a pre-charge circuit via the resistor PTC1 in accordance with the current path g of FIG. 1. If the changeover switch S1 is in the switch position NC, but the changeover switch S2 is also in the switch position NC, then this gives a discharge function via the resistor PTC2 in accordance with the current path r of FIG. 1. The resistor PTC1 is therefore a pre-charge resistor and performs only this function, while the resistor PTC2 is a discharge resistor, and can perform only this function. In FIG. 2, however, the resistor PTC has both functions and can therefore be referred to as a discharge and pre-charge resistor (alternatively: current-limiting resistor). The switch position NO can be referred to as first switch position. The switch position NC can be referred to as second switch position. If the first changeover switch is in the first switch position NO, the respective pre-charge/discharge circuit E1, E2 then connects the first DC voltage terminal (that is to say the positive potential thereof) directly to the positive potential U+ of the intermediate circuit capacitor C, C1. This applies to FIGS. 1 and 2.

If the first changeover switch S1 is in the second switch position NC, the second changeover switch S1 can then be used to choose whether a discharge function or a pre-charge function should be performed. In particular in the switch position NC, a connection arises via the resistor PTC2 and S1 or the resistor PTC and S2 (FIG. 2), which connects the first changeover switch to the potential − of the first DC voltage terminal or to the negative pole U− of the intermediate circuit capacitor C. The order of the discharge resistor and the second changeover switch are different in FIG. 1 and FIG. 2. If the second changeover switch S2 is in the switch position NO, a connection then arises via the second changeover switch and the discharge resistor PTC1 or the resistor PTC, which connects the first changeover switch S1 to the positive potential + of the first DC voltage terminal.

FIG. 3 shows a rectifier GR which is constructed in two parts, where this means that the DC voltage side has a positive potential, a negative potential and an intermediate potential 0. The intermediate potential 0 arises as a result of the serial connection of the rectifier circuits of the rectifier GR. It can be seen that, in the positive voltage rail, a pre-charge/discharge circuit E is provided in which the first changeover switch switchably connects the positive potential + of the first DC voltage terminal to the positive pole U+ of the intermediate circuit capacitor C2. Mirroring this, the discharge circuit E′ provides that the first changeover switch present there switchably connects the negative potential − of the first DC voltage terminal to the negative pole U− of the intermediate circuit capacitor. In the circuits E and E′, in each case the second changeover switches attach to the first changeover switch, either directly (see FIG. 1) or via a resistor (see FIG. 2). The intermediate potential 0 of the multi-part rectifier GR forms, for the construction of the circuits E, E′, the potential which is depicted by the potential − in FIGS. 1 and 2. The discharge circuit E′ is therefore mirrored vertically, i.e. is mirrored in relation to potential 0 and provided opposite the circuit E.

In FIG. 3, two capacitor elements C2 are attached, which are connected in series, which together form the intermediate circuit capacitor. The connecting point between the capacitor elements C2 is connected to the intermediate potential 0. The connecting point between the capacitor elements C2 of FIG. 3 is connected to a discharge resistor which leads to the second changeover switch, or is connected to the second changeover switch which leads to the first changeover switch via the discharge or pre-charge resistor, corresponding to FIGS. 1 and 2 in a mirrored manner. In FIG. 3, a converter W is furthermore provided, which is constructed like the converter W in FIGS. 1 and 2.

For all the depicted examples, the following applies. The control unit ST activates the two changeover switches S1, S2 as well as the converter W, so as thus to provide that, in a first discharge phase, which takes place before the second discharge phase, the converter W is activated in a timed manner at a frequency which lies above the resonant frequency of the resonant circuit CR, L, such as at a frequency which is more than double the resonant frequency. In the first discharge phase, the activation unit ST activates the first changeover switch S1 in accordance with the switch position NO or in accordance with the switch position NC. Any isolation switches provided, which can be arranged upstream or downstream of the rectifier, are open in this case. The control unit changes over to the second discharge phase, in which the switch S1 has the switch position NC, where this also applies to the changeover switch S2. In the second discharge phase, the converter may be activated with open switches (continuously open switches) T1 to T4.

In some examples, in the first discharge phase, the first changeover switch S1 is in the position NC. The second changeover switch S2 may be in the position NO in the first discharge phase. As a result, the discharge resistor is not in the circuit in which the discharge current flows.

In the second discharge phase, the first changeover switch S1 is in the position NC. The second changeover switch S2 is in the position NC in the second discharge phase. This gives a circuit in which the discharge current flows through the discharge resistor.

A diode can be arranged upstream of the potentials +, − (or a diode for each potential), which diode is designed to prevent a flow of current into the discharge circuit E, E′, E1, E2 during the discharge. The diode can be arranged upstream of the first potential + with a forward direction which points toward the intermediate circuit capacitor/toward the discharge circuit, and/or can be arranged upstream of the second potential − with a forward direction pointing away from the intermediate circuit capacitor/away from the discharge circuit.

In the discharge phases, the discharge circuit is isolated from an external charging voltage source or a terminal therefor, wherein this isolation is realized by a rectifier GR (and where appropriate an associated control unit) and/or by at least one diode or at least one isolating switch, which is arranged upstream of the first DC voltage terminal.

In a regeneration or battery recharging phase, the first changeover switch is preferably in the position NO. As a result, current can flow from the first to the second DC voltage terminal without it being passed through one of the resistors PTC1, PTC2 or PCT.

A number of implementations have been described. Nevertheless, it will be understood that various modifications may be made without departing from the spirit and scope of the disclosure. Accordingly, other implementations are within the scope of the following claims.

What is claimed is:

1. A vehicle charging circuit comprising:
a first DC voltage terminal,
a second DC voltage terminal,
a DC voltage converter
upstream intermediate circuit capacitor;
at least one pre-charge/discharge circuit via which the first DC voltage terminal is connected to the intermediate circuit capacitor, the second DC voltage terminal is connected to the intermediate circuit capacitor via the DC voltage converter, wherein the pre-charge/discharge circuit comprises:
at least one first changeover switch, and
a second changeover switch,
wherein in a first position, the first changeover switch produces a direct connection between a first pole of the intermediate circuit capacitor and a first potential of the first DC voltage terminal,
wherein, in a second position, the first changeover switch connects the first pole of the intermediate circuit capacitor to a second pole of the intermediate circuit capacitor via a discharge resistor and via the second changeover switch, and
wherein:
a) the second changeover switch connects the discharge resistor: to the first potential of the first DC voltage terminal in a first switch position, or to the second pole of the intermediate circuit capacitor in a second switch position, or
b) the second changeover switch connects the first changeover switch: to the first potential of the first DC voltage terminal via a pre-charge resistor in a first switch position, or to the discharge resistor in a second switch position; and
an activation unit which, in a first discharge phase, activates the DC voltage converter to convert the voltage of the intermediate circuit capacitor into heat by way of the DC voltage converter and not by way of the discharge resistor, and, in a second discharge phase, activates the first and second changeover switch to adopt the second position in each case.

2. The vehicle charging circuit of claim 1, wherein the first changeover switch and/or the second changeover switch adopts the second position in an activation-free state.

3. The vehicle charging circuit of claim 1, further comprising:
a controlled rectifier or power factor correction filter having a direct-current side connected to the first DC voltage terminal, and an alternating-current side connected to a single-phase or three-phase alternating-current terminal.

4. The vehicle charging circuit of claim 3, wherein the rectifier has two rectifier circuits serially connected on the direct-current side, each rectifier circuit is arranged downstream of one of the pre-charge/discharge circuits, wherein the intermediate circuit capacitor has two serial capacitor elements connected to the second DC voltage terminal via the DC voltage converter.

5. The vehicle charging circuit of claim 3, wherein the DC voltage converter has a resonant circuit and switches connected thereto, wherein the activation unit activates the DC voltage converter outside a resonant frequency of the resonant circuit in the first discharge phase and in particular above this resonant frequency.

6. The vehicle charging circuit of claim 5, wherein the switches form two half-bridges, each with a connecting point, wherein the half-bridges are attached to the intermediate circuit capacitor and the connecting points, which form two poles of the second DC voltage terminal, are connected to one another via the resonant circuit.

7. The vehicle charging circuit of claim 5, wherein the resonant circuit is a series circuit comprising a working capacitance and a working inductance.

8. The vehicle charging circuit of claim 5, wherein the DC voltage converter has, arranged downstream of the resonant circuit, a converter-rectifier circuit, the direct-current side connected to the second DC voltage terminal.

9. The vehicle charging circuit of claim 1, wherein the activation unit is designed to activate an isolation device and/or a controllable rectifier circuit arranged upstream of the first DC voltage terminal with open switching position before the first discharge phase and to carry out the first and the second discharge phase while the activation unit activates the open switching position.

10. The vehicle charging circuit of claim 1, wherein the activation unit transitions from the first discharge phase into the second discharge phase if the voltage applied to the intermediate circuit capacitor falls below a predetermined limit value.
